(19) United States
(12) Patent Application Publication
(10) Pub. No.: US 2025/0239879 A1
(43) Pub. Date: Jul. 24, 2025

(54) ONBOARD CONTROL APPARATUS

(71) Applicants: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(72) Inventor: Kazushi SHIMAMOTO, Yokkaichi-shi, Mie (JP)

(73) Assignees: AutoNetworks Technologies, Ltd., Yokkaichi-shi, Mie (JP); Sumitomo Wiring Systems, Ltd., Yokkaichi-shi, Mie (JP); Sumitomo Electric Industries, Ltd., Osaka-shi, Osaka (JP)

(21) Appl. No.: 18/701,059

(22) PCT Filed: Oct. 15, 2021
(86) PCT No.: PCT/JP2021/038194

§ 371 Date: Apr. 12, 2024

(51) Int. Cl. H02J 7/00; H02J 7/34; H02J 9/06

(52) U.S. Cl. CPC H02J 7/007182; H02J 7/0047; H02J 7/0063; H02J 7/342; H02J 7/345; H02J 9/061; H02J 2207/50; H02J 2310/40

(57) ABSTRACT

An onboard control apparatus for an onboard system including: a power source unit, a power storage unit, a charge unit performing a charge operation providing a current to the power storage unit based on power supplied from the power source unit, and a discharge unit performing a discharge operation causing a current to flow to the load side based on power that is supplied from power storage unit. The onboard control apparatus includes a control unit for controlling the charge unit and the discharge unit and causes the discharge unit to perform a discharge operation when a voltage of a power path is lower than or equal to a threshold voltage, and causes the charge unit to perform a charge operation when a voltage of the power storage unit is lower than or equal to a predetermined value.

### CROSS-REFERENCE TO RELATED APPLICATIONS

This application is the U.S. national stage of PCT/JP2021/038194 filed on Oct. 15, 2021, the contents of which are incorporated herein.

### TECHNICAL FIELD

The present disclosure relates to an onboard control apparatus.

### BACKGROUND

JP 2011-24288A discloses a power source apparatus that has a backup function. This power source apparatus supplies electric power to a load circuit using power provided from an AC-DC conversion power source when a power source unit (AC power source) is in operation, and supplies power to the load circuit using power stored in a power storage unit (battery) when the power source unit (AC power source) is stopped.

In JP 2011-24288A, the power storage unit (battery) is used only when the power source unit (AC power source) is stopped.

The present disclosure provides a technique that can increase the use range of a power storage unit provided separately from a power source unit.

### SUMMARY

An onboard control apparatus according to the present disclosure is used for an onboard system, the onboard system includes: a power source unit, a power storage unit different from the power source unit, a power path that is a path for supplying power from the power source unit to a load, a charge unit configured to perform a charge operation of suppling a current to the power storage unit based on power that is supplied from the power source unit, and a discharge unit configured to perform a discharge operation of causing a current to flow to the load side based on power that is supplied from the power storage unit, and the charge operation by the charge unit and the discharge operation by the discharge unit are controlled, the onboard control apparatus includes a control unit configured to control the charge unit and the discharge unit, and the control unit causes the discharge unit to perform the discharge operation when a voltage of the power path is lower than or equal to a threshold voltage, and causes the charge unit to perform the charge operation when a voltage of the power storage unit is lower than or equal to a predetermined value.

### Advantageous Effects

According to the present disclosure, it is possible to increase use range of a power storage unit provided separately from a power source unit.

### BRIEF DESCRIPTION OF DRAWINGS

FIG. 1 is a configuration diagram schematically showing an onboard system according to a first embodiment.

FIG. 2 is an explanatory diagram conceptually showing the onboard system in a state of supplying power from a power source unit to a load and a power storage unit.

FIG. 3 is an explanatory diagram conceptually showing the onboard system in a state of performing a discharge operation while supplying power from the power source unit to the load.

FIG. 4 is a timing chart showing the state of the onboard system when a state where power supply from the power source unit to the load is sufficient changes to a state where such power supply is insufficient.

FIG. 5 is an explanatory diagram conceptually showing the onboard system in a state of performing a discharge operation.

FIG. 6 is an explanatory diagram conceptually showing the onboard system in a state of performing a discharge operation and a charge operation in parallel.

FIG. 7 is a timing chart showing the state of the onboard system when a state where the power source unit is supplying power changes to a state where power supply that is based on the power source unit stops.

FIG. 8 is an explanatory diagram conceptually showing the onboard system when a discharge operation is performed in a state where power supply from the power source unit has stopped.

### DETAILED DESCRIPTION OF PREFERRED EMBODIMENTS

Hereinafter, embodiments of the present disclosure will be listed and described.

An onboard control apparatus according to the present disclosure is used for an onboard system, the onboard system includes: a power source unit, a power storage unit different from the power source unit, a power path that is a path for supplying power from the power source unit to a load, a charge unit configured to perform a charge operation of suppling a current to the power storage unit based on power that is supplied from the power source unit, and a discharge unit configured to perform a discharge operation of causing a current to flow to the load side based on power that is supplied from the power storage unit, and the charge operation by the charge unit and the discharge operation by the discharge unit are controlled, the onboard control apparatus includes a control unit configured to control the charge unit and the discharge unit, and the control unit causes the discharge unit to perform the discharge operation when a voltage of the power path is lower than or equal to a threshold voltage, and causes the charge unit to perform the charge operation when a voltage of the power storage unit is lower than or equal to a predetermined value.

A case may occur in which power that is supplied to the load is insufficient although power supply from the power source unit has not stopped. Degradation of the power source unit, a plurality of loads operating at the same time, and the like are envisioned as the cause of such a case, for example.

In preparation for such a situation, the onboard control apparatus is configured to cause the discharge unit to perform the discharge operation when the voltage of the power path is lower than or equal to the threshold voltage, even when power supply from the power path has not been stopped. For this reason, the onboard control apparatus can keep power that is supplied to the load from becoming insufficient using the power storage unit. Note that, when power of the power storage unit is consumed in a state where power supply from the power source unit has not stopped, there is a risk that, when power supply from the power source unit stops, it is not possible to cause the load to perform an operation responding to such a stopped state. In this regard, when the voltage of the power storage unit is lower than or equal to the predetermined value, the onboard control apparatus causes the charge unit to perform the charge operation. For this reason, it is possible to suppress the occurrence of a situation where, when power supply from a power source unit 10 stops, it is not possible to cause a load to perform an operation responding to such a stopped state.

When a predetermined condition is met, the control unit may cause the discharge operation by the discharge unit and the charge operation by the charge unit to be performed in parallel.

By causing the discharge operation and the charge operation to be performed in parallel when a predetermined condition is met, the onboard control apparatus can more reliably suppress the occurrence of a situation where, when power supply from the power source unit stops, it is not possible to cause the load to perform an operation responding to such a stopped state.

During a period during which the discharge operation and the charge operation are performed in parallel, the control unit may perform control such that power that is supplied to the power storage unit by the charge unit is higher than or equal to power that is supplied by the discharge unit through discharging.

The onboard control apparatus can keep the voltage of the power storage unit from decreasing further by supplying, to the power storage unit, power that is higher than or equal to power that is supplied by the discharge unit through discharging, and, as a result, it is possible to more reliably suppress the occurrence of a situation where, when power supply from the power source unit stops, it is not possible to cause the load to perform an operation responding to such a stopped state.

The predetermined value may be a value that is lower than or equal to the threshold voltage.

The onboard control apparatus can cause the charge unit to perform a charge operation when the voltage of the power storage unit is lower than or equal to a predetermined value set to a value lower than or equal to the threshold voltage.

The control unit may perform predetermined processing when the voltage of the power path is lower than or equal to a second threshold voltage that is lower than the threshold voltage.

When the voltage of the power path is lower than or equal to the second threshold voltage that is yet lower than the threshold voltage, the onboard control apparatus can perform predetermined processing. For this reason, for example, the onboard control apparatus can perform the predetermined processing when power supply from the power source unit stops.

In the predetermined processing, the control unit may cause the charge unit to stop the charge operation while causing the discharge unit to perform the discharge operation.

When the voltage of the power path is lower than or equal to the second threshold voltage, the onboard control apparatus can cause the charge unit to stop a charge operation while causing the discharge unit to perform a discharge operation. For this reason, power that is based on the power storage unit can be supplied to the load while preventing the power storage unit from being short-circuited to the power path via the charge unit.

The discharge unit may include an output conductive path that is a path for supplying a discharge current to the load side, and a voltage conversion circuit for performing a voltage conversion operation of converting an input voltage that is based on the power storage unit and applying an output voltage to the output conductive path. A disconnection portion configured to stop power supply from the output conductive path to a path on the load side may be further provided. The control unit may cause the voltage conversion circuit to perform the voltage conversion operation even in a state where the voltage of the power path exceeds the threshold voltage. The disconnection portion may be configured to cause a current to flow from the output conductive path to the path on the load side when the voltage of the power path decreases to the threshold voltage or lower.

When the voltage of the power path decreases to the threshold voltage or lower, the onboard control apparatus can immediately cause a desired discharge current to flow to the load side, by keeping the voltage conversion circuit performing the voltage conversion operation even in a state where the voltage of the power path exceeds the threshold voltage.

The control unit may cause the discharge operation to be stopped in a state where the voltage of the power path exceeds the threshold voltage, and cause the discharge operation to be started when the voltage of the power path decreases to the threshold voltage or lower.

The onboard control apparatus can suppress power consumption by stopping the discharge operation in a state where the voltage of the power path exceeds the threshold voltage.

A switch constituted by an FET may be provided on the power path. A discharge path may be provided between the discharge unit and a connection portion between the switch and the load. The discharge unit may perform the discharge operation such that a current flows through the discharge path. The switch may stop flow of a current from the load side to the power source unit side via the switch itself in an off-state, and allow such flow in an on-state.

The onboard control apparatus can prevent a current that flowed from the discharge unit to the discharge path from flowing to the power source unit side, by switching the switch constituted by an FET to an off-state.

A program according to the present disclosure is a program that is executed by a computer of an onboard control apparatus that is used for an onboard system, the onboard system includes: a power source unit, a power storage unit different from the power source unit, a power path that is a path for supplying power from the power source unit to a load, a charge unit configured to perform a charge operation of suppling a current to the power storage unit based on power that is supplied from the power source unit, and a discharge unit configured to perform a discharge operation of causing a current to flow to the load side based on power that is supplied from the power storage unit, and the program includes a step of causing the discharge unit to perform the discharge operation when a voltage of the power path is lower than or equal to a threshold voltage, and a step of causing the charge unit to perform the charge operation when a voltage of the power storage unit is lower than or equal to predetermined value.

A vehicle control method according to the present disclosure is a control method that is executed by a computer of an onboard control apparatus that is used for an onboard system, the onboard system includes: a power source unit, a power storage unit different from the power source unit, a power path that is a path for supplying power from the power source unit to a load, a charge unit configured to perform a charge operation of suppling a current to the power storage unit based on power that is supplied from the power source unit, and a discharge unit configured to perform a discharge operation of causing a current to flow to the load side based on power that is supplied from the power storage unit, and the control method includes: a step of causing the discharge unit to perform the discharge operation when a voltage of the power path is lower than or equal to a threshold voltage, and a step of causing the charge unit to perform the charge operation when a voltage of the power storage unit is lower than or equal to predetermined value.

### First Embodiment

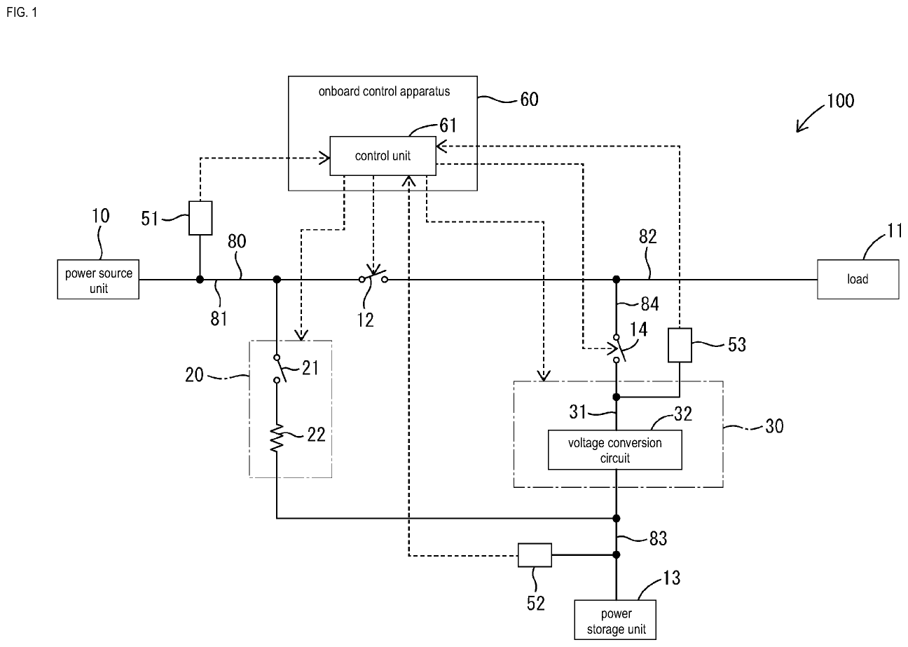

An onboard system 100 shown in FIG. 1 includes a power source unit 10, a load 11, and a power path 80. The power source unit 10 functions as a main power source that supplies power to a plurality of types of loads. The power source unit 10 is configured as a known onboard battery such as a lead battery. The load 11 is a load that performs, when power supply that is based on the power source unit 10 stops, for example, an operation responding to such a stopped state based on power supplied from a later-described power storage unit 13. “An operation responding to such a stopped state” is an operation necessary for a vehicle to safely stop, for example. The load 11 is a shift-by-wire control system, an electronically controlled braking system, or the like. The power path 80 is a path for supplying power from the power source unit 10 to the load 11.

The onboard system 100 includes a first switch 12. The first switch 12 is configured as an FET (Field Effect Transistor), for example. The first switch 12 is equivalent to an example of a “switch”. The first switch 12 stops flow of a current from the load 11 side to the power source unit 10 side via the first switch 12 itself in an off-state, and allows such flow in an on-state. The first switch 12 is provided on the power path 80. The power path 80 includes a first power path 81 on the power source unit 10 side relative to the first switch 12, and a second power path 82 on the load 11 side relative to the first switch 12. The second power path 82 is equivalent to an example of a “connection portion between a switch and a load”.

The onboard system 100 includes the power storage unit 13 and a conductive path 83. The power storage unit 13 is constituted by a known power storage means such as an electric double layer capacitor (EDLC). When power supply that is based on the power source unit 10 is insufficient, the power storage unit 13 functions as a backup power source for supplying power to the load 11. The power storage unit 13 is electrically connected to the conductive path 83. The voltage of the power storage unit 13 is applied to the conductive path 83. Note that, in the present specification, “being electrically connected” includes a configuration of being electrically connected via a switching element.

The onboard system 100 includes a charge unit 20 and a discharge unit 30. The charge unit 20 is provided between the first power path 81 and the power storage unit 13, and performs a charge operation of supplying a current to the power storage unit 13 based on power supplied from the power source unit 10. The charge unit 20 includes a second switch 21 and a resistance portion 22. The second switch 21 is configured as an FET (Field Effect Transistor), for example. The resistance portion 22 is configured as a resistor, for example. The second switch 21 and the resistance portion 22 are connected in series to each other. The second switch 21 is disposed on the power source unit 10 side relative to the resistance portion 22. One end of the second switch 21 is electrically connected to the first power path 81. One end of the resistance portion 22 is electrically connected to the power storage unit 13 via the conductive path 83. The other end of the second switch 21 is electrically connected to the other end of the resistance portion 22. The charge unit 20 performs a charge operation by the second switch 21 being switched to an on-state, and stops the charge operation by the second switch 21 being switched to an off-state.

The discharge unit 30 is provided between the power storage unit 13 and the second power path 82, and performs a discharge operation of causing a current to flow to the load 11 side based on power supplied from the power storage unit 13. The discharge unit 30 includes an output conductive path 31 and a voltage conversion circuit 32. The output conductive path 31 is a path for supplying a discharge current to the load 11 side. One end of the output conductive path 31 is electrically connected to the second power path 82 via a later-described discharge path 84. One end of the voltage conversion circuit 32 is electrically connected to the power storage unit 13 via the conductive path 83, and the other end of the voltage conversion circuit 32 is electrically connected to the other end of the output conductive path 31. The voltage conversion circuit 32 performs a voltage conversion operation of converting an input voltage that is based on the power storage unit 13, and applying an output voltage to the output conductive path 31. The voltage conversion circuit 32 is a DCDC converter (for example, a step-up DCDC converter), and increases an input voltage that is based on the power storage unit 13 and applies an output voltage to the output conductive path 31. The discharge unit 30 performs a discharge operation by the voltage conversion circuit 32 performing a voltage conversion operation, and stops a discharge operation by the voltage conversion circuit 32 stopping a voltage conversion operation.

The onboard system 100 includes the discharge path 84 and a disconnection portion 14. The discharge path 84 is provided between the second power path 82 and the discharge unit 30. The disconnection portion 14 is provided on the discharge path 84. The disconnection portion 14 is configured as a switching element, more specifically an FET (Field Effect Transistor), for example. The disconnection portion 14 can stop flow of a current from the output conductive path 31 to the path on the load 11 side (for example, the second power path 82). The disconnection portion 14 is switched between a disconnected state (in the present embodiment, an off-state) in which flow of a current from the output conductive path 31 to the path on the load 11 side (for example, the second power path 82) via the disconnection portion 14 itself is stopped, and an allowed state (in the present embodiment, an on-state) in which such flow is allowed. The disconnection portion 14 is switched to the disconnected state when the voltage of the power path 80 exceeds a first threshold voltage Vth1, and the allowed state when the voltage of the power path 80 decreases to the first threshold voltage Vth1 or lower. The first threshold voltage Vth1 is a value that is higher than or equal to a voltage required for the load 11 to operate, and is larger than 0 V. The first threshold voltage Vth1 is equivalent to an example of a “threshold voltage”.

The onboard system 100 includes a first voltage detection unit 51, a second voltage detection unit 52, and a third voltage detection unit 53. The first voltage detection unit 51, the second voltage detection unit 52, and the third voltage detection unit 53 are each configured as a known voltage detection circuit. The first voltage detection unit 51 detects the voltage of the power path 80 (more specifically, the first power path 81), and outputs a signal that enables a detected value to be specified. The second voltage detection unit 52 detects the voltage of the conductive path 83, in other words, the voltage of the power storage unit 13, and outputs a signal that enables a detected value to be specified. The third voltage detection unit 53 detects the voltage of the output conductive path 31, and outputs a signal that enables a detected value to be specified.

The onboard system 100 includes an onboard control apparatus 60. The onboard control apparatus 60 is used for the onboard system 100, and controls a charge operation that is performed by the charge unit 20 and a discharge operation that is performed by the discharge unit 30. The onboard control apparatus 60 includes a control unit 61.

The control unit 61 is configured as an MCU (Micro Controller Unit), for example. Signals output from the first voltage detection unit 51, the second voltage detection unit 52, and the third voltage detection unit 53 are input to the control unit 61. The control unit 61 specifies, based on these signals, the voltage of the power path 80 (more specifically, the first power path 81), the voltage of the power storage unit 13, and the voltage of the output conductive path 31 (in other words, an output voltage of the discharge unit 30).

The control unit 61 controls the first switch 12, the disconnection portion 14, the charge unit 20, and the discharge unit 30. The control unit 61 can adjust power that is supplied from the power source unit 10 side to the power storage unit 13 side by performing duty control of the second switch 21 of the charge unit 20, for example. The control unit 61 causes the voltage conversion circuit 32 to perform a voltage conversion operation such that a voltage that is applied to the output conductive path 31 is the first threshold voltage Vth1, for example.

The control unit 61 causes the discharge unit 30 to perform a discharge operation if the voltage of the power path 80 (more specifically, the first power path 81) is lower than or equal to the first threshold voltage Vth1, and causes the charge unit 20 to perform a charge operation if the voltage of the power storage unit 13 is lower than or equal to a predetermined value Vth3. In the present embodiment, the predetermined value Vth3 is a value larger than 0 V and smaller than the first threshold voltage Vth1.

When a predetermined condition is met, the control unit 61 causes a discharge operation by the discharge unit 30 and a charge operation by the charge unit 20 to be performed in parallel. In the present embodiment, even when the voltage of the power path 80 (more specifically, the first power path 81) exceeds the first threshold voltage Vth1, the control unit 61 causes the voltage conversion circuit 32 to perform a voltage conversion operation. That is to say, in the present embodiment, the predetermined condition is that the voltage of the power storage unit 13 has decreased to the predetermined value Vth3 or lower.

During a period during which a discharge operation and a charge operation are performed in parallel, the control unit 61 performs control such that power that is supplied to the power storage unit 13 by the charge unit 20 is higher than or equal to power that is supplied by the discharge unit 30 through discharging. A specific control method is not limited. The control unit 61 may calculate power that is supplied per unit time by the discharge unit 30 through discharging, and cause the charge unit 20 to perform a charge operation such that power that is supplied per unit time to the power storage unit 13 by the charge unit 20 is higher than or equal to the calculated value, for example. “Power that is supplied per unit time by the discharge unit 30 through discharging” may be calculated based on the voltage of the output conductive path 31 and a current flowing through the output conductive path 31, for example. “Power that is supplied per unit time to the power storage unit 13 by the charge unit 20” may also be calculated based on the voltage of the path between the charge unit 20 and the conductive path 83, and a current flowing through the path, for example. In addition, as another example, the control unit 61 may cause the charge unit 20 to perform a charge operation such that the voltage of the power storage unit 13 is higher than or equal to the voltage of the power storage unit 13 when a predetermined condition is met.

The control unit 61 performs predetermined processing when the voltage of the power path 80 is lower than or equal to a second threshold voltage Vth2 that is lower than the first threshold voltage Vth1. The second threshold voltage Vth2 is a value that is higher than or equal to 0 V. In predetermined processing, the control unit 61 causes the charge unit 20 to stop a charge operation while causing the discharge unit 30 to perform a discharge operation.

Even in a state where the voltage of the power path 80 exceeds the first threshold voltage Vth1, the control unit 61 causes the voltage conversion circuit 32 to perform a voltage conversion operation. In a state where the voltage of the power path 80 exceeds the first threshold voltage Vth1, the control unit 61 switches the disconnection portion 14 to a disconnected state, and causes the voltage conversion circuit 32 to perform a voltage conversion operation. Then, when the voltage of the power path 80 decreases to the first threshold voltage Vth1 or lower, the control unit 61 switches the disconnection portion 14 to an allowed state while keeping the voltage conversion circuit 32 performing a voltage conversion operation. Accordingly, when the voltage of the power path 80 decreases to the first threshold voltage Vth1 or lower, the onboard control apparatus 60 can immediately cause a desired discharge current to flow from the disconnection portion 14 to the load 11 side.

The following description relates to operations of the onboard control apparatus 60.

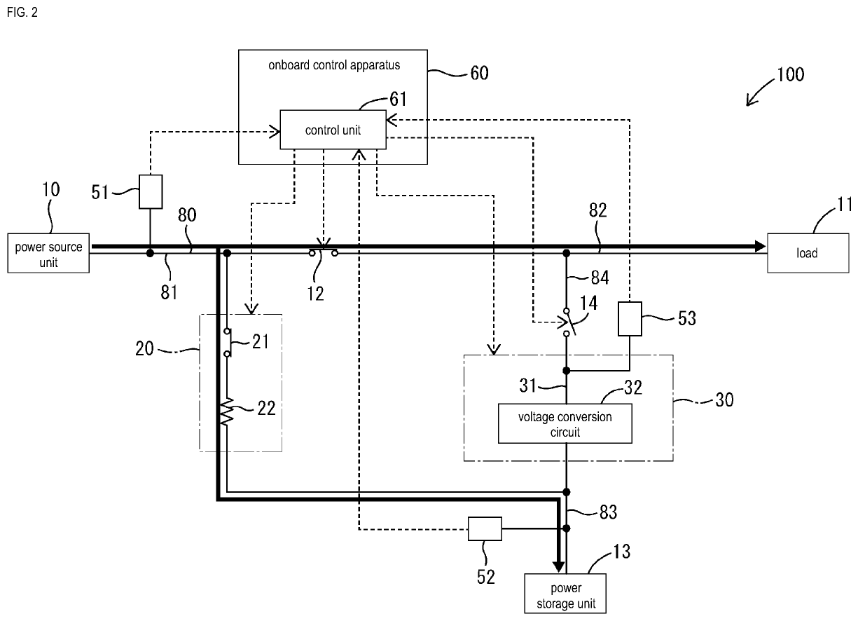

When a start condition is met, as shown in FIG. 2, the control unit 61 switches the first switch 12 to an on-state, and causes the charge unit 20 to perform charge operation. That is to say, the control unit 61 switches the first switch 12 and the second switch 21 to an on-state. Accordingly, power is supplied to the load 11 and the power storage unit 13 based on power supplied from the power source unit 10. In addition, a condition for starting the charge unit 20 may be that the start switch of the vehicle in which the onboard system 100 is mounted has been switched to an on-state, for example. The start switch is an ignition switch, for example. The “start switch has been switched to an on-state” refers to a configuration where an on-off signal that enables the on/off-state of the start switch to be specified is input to the control unit 61, for example, and the control unit 61 may perform determination based on this on-off signal.

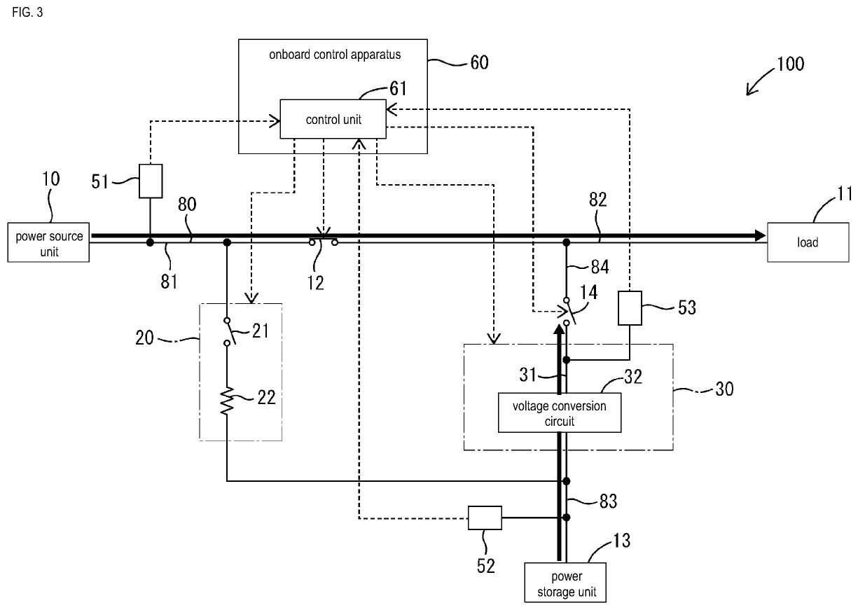

When a charge completion condition is met, as shown in FIG. 3, the control unit 61 causes the charge unit 20 to stop a charge operation, and causes the discharge unit 30 to perform a discharge operation. That is to say, the control unit 61 switches the second switch 21 to an off-state, and causes the voltage conversion circuit 32 to perform a voltage conversion operation. Accordingly, the first threshold voltage Vth1 is applied to the output conductive path 31. Note that flow of a current from the discharge unit 30 side to the load 11 side is stopped by the disconnection portion 14. The charge completion condition is that the voltage of the power storage unit 13 has reached a charge complete voltage, for example. The charge complete voltage takes a value that is higher than or equal to the predetermined value Vth3.

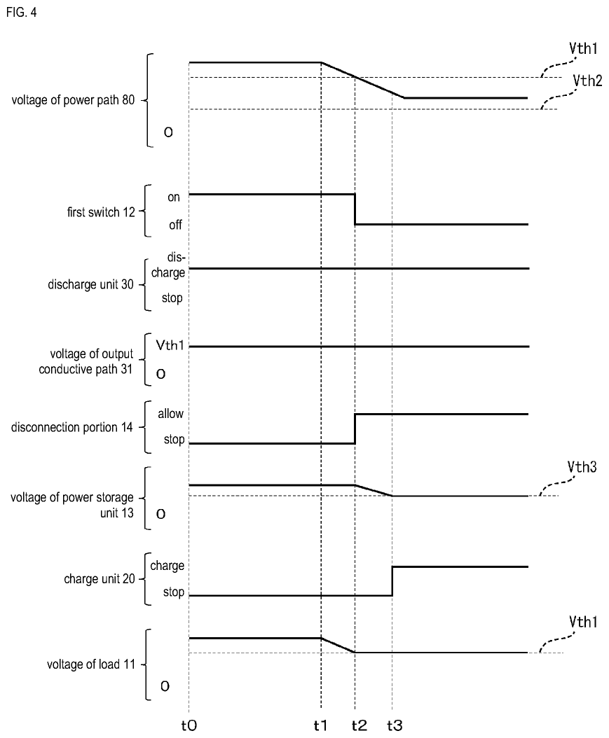

FIG. 4 shows a timing chart showing the state of the onboard system 100 when the state shown in FIG. 3 changes to a state where power that is supplied from the power source unit 10 to the load 11 is insufficient. The state at timing to in FIG. 4 is the state shown in FIG. 3. That is to say, the voltage of the power path 80 is maintained at a value that is higher than the first threshold voltage Vth1. The first switch 12 is in an on-state. The discharge unit 30 is performing a discharge operation. The voltage of the output conductive path 31 is maintained at the first threshold voltage Vth1. The disconnection portion 14 is in a disconnected state. The value of the voltage of the power storage unit 13 is a value higher than the predetermined value Vth3. The charge unit 20 has stopped a charge operation. The value of the voltage of the load 11 is higher than the first threshold voltage Vth1.

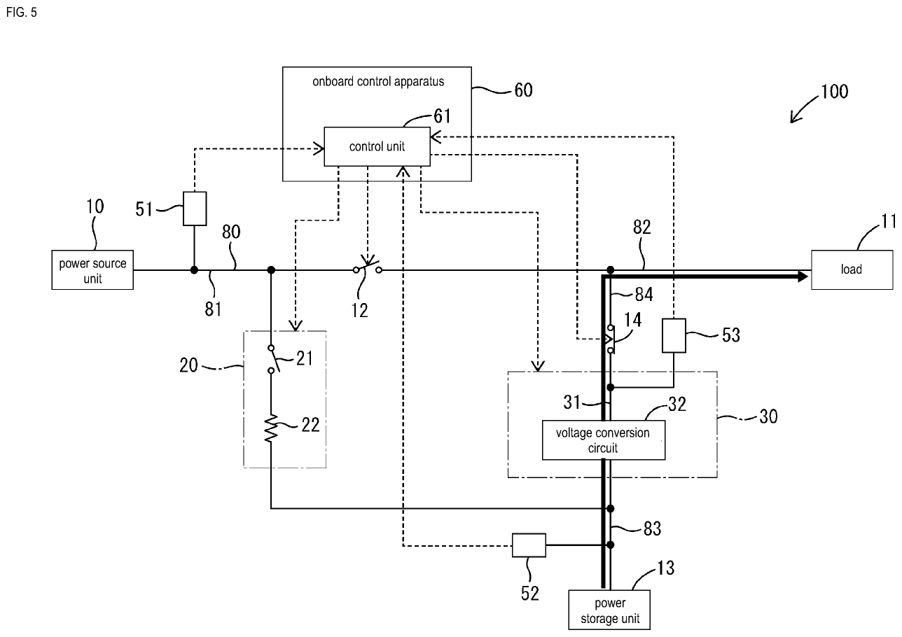

At timing t1, the voltage of the power path 80 starts to decrease due to a plurality of loads operating at the same time, or the like. Then, at timing t2, the voltage of the power path 80 is lower than or equal to the first threshold voltage Vth1. For this reason, as shown in FIG. 5, the control unit 61 switches the first switch 12 to an off-state, and switches the disconnection portion 14 to an allowed state. As a result, the disconnection portion 14 causes a current to flow from the output conductive path 31 to a path on the load 11 side (for example, the second power path 82). Accordingly, power that is based on the power storage unit 13 is supplied to the load 11.

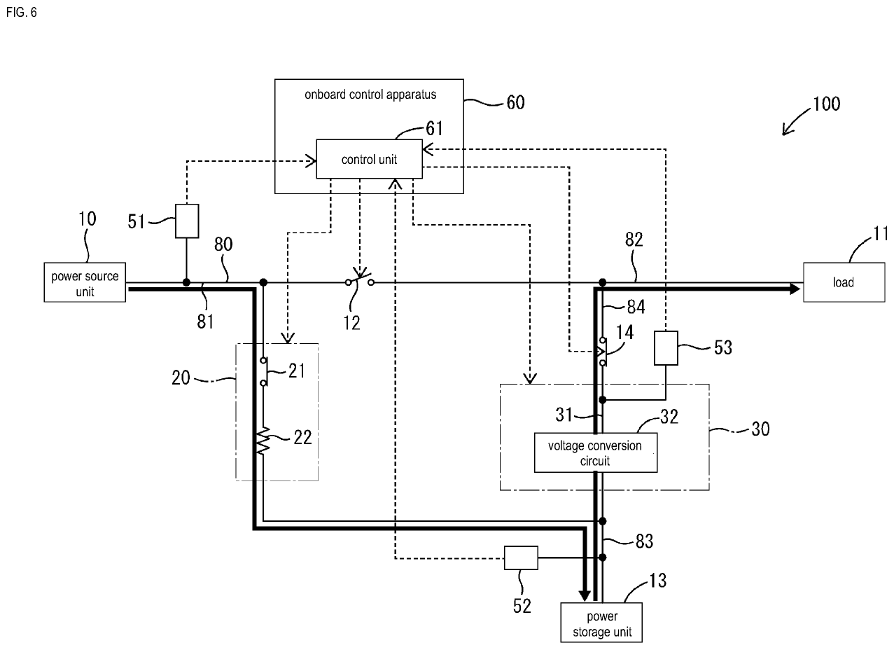

When power that is based on the power storage unit 13 is supplied to the load 11, the voltage of the power storage unit 13 gradually decreases. Then, at timing t3, the voltage of the power storage unit 13 decreases to the predetermined value Vth3 or lower. For this reason, as shown in FIG. 6, the control unit 61 causes the charge unit 20 to start a charge operation. The control unit 61 performs control such that power that is supplied to the power storage unit 13 by the charge unit 20 is power that is supplied by the discharge unit 30 through discharging. Accordingly, the voltage of the power storage unit 13 is maintained at the first threshold voltage Vth1.

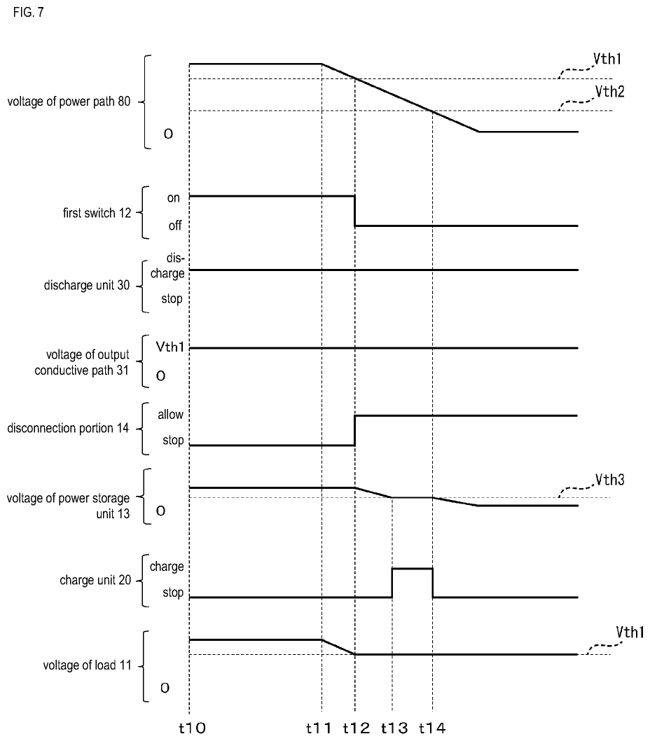

In addition, FIG. 7 shows a timing chart showing the state of the onboard system 100 when the state shown in FIG. 3 changes to a state where power supply from the power source unit 10 stops. The state at timing t10 in FIG. 7 is the state shown in FIG. 3.

At timing t11, due to a plurality of loads operating at the same time, the voltage of the power path 80 starts to decrease. Then, at timing t12, the voltage of the power path 80 is lower than or equal to the first threshold voltage Vth1. For this reason, as shown in FIG. 5, the control unit 61 switches the first switch 12 to an off-state, and switches the disconnection portion 14 to an allowed state. As a result, the disconnection portion 14 causes a current to flow from the output conductive path 31 to a path on the load 11 side (for example, the second power path 82). Accordingly, power that is based on the power storage unit 13 is supplied to the load 11.

When power that is based on the power storage unit 13 is supplied to the load 11, the voltage of the power storage unit 13 gradually decreases. Then, at timing t13, the voltage of the power storage unit 13 is lower than or equal to the predetermined value Vth3. For this reason, as shown in FIG. 6, the control unit 61 causes the charge unit 20 to start a charge operation. The control unit 61 performs control such that power that is supplied to the power storage unit 13 by the charge unit 20 is power that is supplied by the discharge unit 30 through discharging. Accordingly, the voltage of the power storage unit 13 is maintained at the first threshold voltage Vth1.

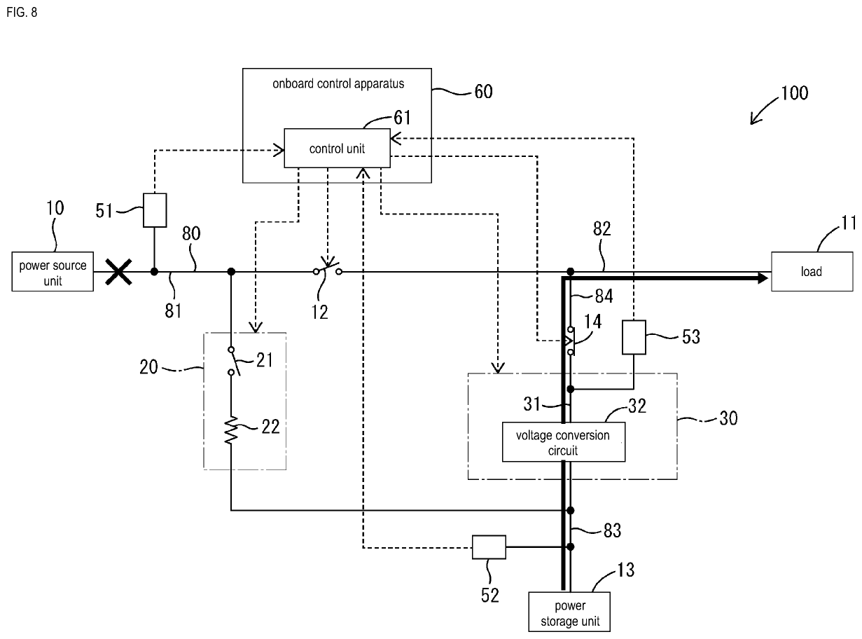

At timing t14, the voltage of the power path 80 decreases to the second threshold voltage Vth2 or lower. For this reason, the control unit 61 performs predetermined processing. That is to say, as shown in FIG. 8, the control unit 61 causes the charge unit 20 to stop a charge operation. Accordingly, a current flowing from the power storage unit 13 can be prevented from flowing to the power source unit 10 side via the charge unit 20.

The above description relates to effects of the onboard control apparatus 60.

A case may occur in which power that is supplied to the load 11 is insufficient even when power supply from the power source unit 10 has not stopped. Degradation of the power source unit 10, a plurality of loads 11 operating at the same time, and the like are envisioned as the cause of such a case.

In preparation for such a situation, even when power supply from the power path 80 has not been stopped, the onboard control apparatus 60 causes the discharge unit 30 to perform a discharge operation when the voltage of the power path 80 is lower than or equal to the first threshold voltage Vth1. For this reason, the onboard control apparatus 60 can keep power that is supplied to the load 11 from being insufficient, using the power storage unit 13. Note that, if power of the power storage unit 13 is consumed in a state where power supply from the power source unit 10 is not stopped, there is a risk that, when power supply from the power source unit 10 stops, it is not possible to cause the load 11 to perform an operation responding to such a stopped state. In this regard, when the voltage of the power storage unit 13 is lower than or equal to the predetermined value Vth3, the onboard control apparatus 60 causes the charge unit 20 to perform a charge operation. For this reason, it is possible to suppress the occurrence of a situation where, when power supply from the power source unit 10 stops, it is not possible to cause the load 11 to perform an operation responding to such a stopped state.

Furthermore, by causing a discharge operation and a charge operation to be performed in parallel when a predetermined condition is met, the onboard control apparatus 60 can more reliably suppress the occurrence of a situation where, when power supply from the power source unit 10 stops, it is not possible to cause the load 11 to perform an operation responding to such a stopped state.

Furthermore, the onboard control apparatus 60 can prevent the voltage of the power storage unit 13 from decreasing further by supplying, to the power storage unit 13, power that is higher than or equal to power that is supplied by the discharge unit 30 through discharging, and, as a result, it is possible to more reliably suppress the occurrence of a situation where, when power supply from the power source unit 10 stops, it is not possible to cause the load 11 to perform an operation responding to such a stopped state.

Furthermore, the onboard control apparatus 60 can cause the charge unit 20 to perform a charge operation, when the voltage of the power storage unit 13 is lower than or equal to the predetermined value Vth3 set to a value lower than or equal to the first threshold voltage Vth1.

Furthermore, the onboard control apparatus 60 can cause the charge unit 20 to stop a charge operation while causing the discharge unit 30 to perform a discharge operation, when the voltage of the power path 80 is lower than or equal to the second threshold voltage Vth2 that is yet lower than the first threshold voltage Vth1. For this reason, it is possible to supply, to the load 11, power that is based on the power storage unit 13 while keeping the power storage unit 13 from being short-circuited to the power path 80 via the charge unit 20.

Furthermore, by causing the voltage conversion circuit 32 to perform a voltage conversion operation even in a state where the voltage of the power path 80 exceeds the first threshold voltage Vth1, the onboard control apparatus 60 can immediately cause a desired discharge current to flow to the load 11 side when the voltage of the power path 80 decreases to the first threshold voltage Vth1 or lower.

Furthermore, the onboard control apparatus 60 can prevent a current that flowed from the discharge unit 30 to the discharge path 84 from flowing to the power source unit 10 side, by switching the first switch 12 constituted by an FET, to an off-state.

### Other Embodiments

The present disclosure is not limited to the embodiments described above and with reference to the drawings. Any combination of characteristics in the embodiments described above and below can be made as long as no contradictions arise. In addition, any characteristics in the embodiment described above and below can be omitted unless explicitly stated as essentials. Furthermore, the above embodiments may be changed as follows.

In the above embodiment, the predetermined value is a value smaller than the first threshold voltage, but may be the same value as the first threshold voltage, or may be a value larger than the first threshold voltage.

In the above embodiment, the predetermined condition is that “the voltage of the power storage unit has decreased to a predetermined value or lower”, but another condition may be used. The predetermined condition may be that “the voltage of the power path has decreased to the first threshold voltage or lower”, for example.

In the above embodiment, the control unit is configured to cause the charge unit to stop a charge operation while causing the discharge unit to perform a discharge operation in predetermined processing, but another configuration may be adopted. The control unit may also be configured to output a notification signal to the outside in predetermined processing, for example. With this configuration, an external apparatus that has received a notification signal can notify the user of the vehicle or the like that the voltage of power has decreased to the second threshold or lower.

In the above embodiment, the disconnection portion is a switching element, but another configuration may be adopted as long as the disconnection portion is an element that can stop power supply from the output conductive path to the path on the load side in a state where the voltage of the power path exceeds the first threshold voltage. The disconnection portion may be a diode, for example. The anode of the diode is electrically connected to the path on the discharge unit side, and the cathode thereof is electrically connected to the path on the second power path side.

The first switch according to the above embodiment may be replaced with another element as long as the element can stop flow of a current from the load side to the power source unit side. The first switch may be replaced with a diode, for example. The anode of the diode is electrically connected to the first power path, and the cathode is electrically connected to the second power path.

The control unit according to the above embodiment is configured to cause the voltage conversion circuit to perform a voltage conversion operation even in a state where the voltage of the power path exceeds the first threshold voltage, but another configuration may be adopted. The control unit may also be configured to cause the discharge unit (for example, the voltage conversion circuit) to stop a discharge operation (for example, a voltage conversion operation) in a state where the voltage of the power path exceeds the first threshold voltage, and cause the discharge unit (for example, the voltage conversion circuit) to start a discharge operation (voltage conversion operation) when the voltage of the power path decreases to the first threshold voltage or lower, for example.

A configuration is adopted in which the charge unit according to the above embodiment includes a second switch and a resistance portion, but another configuration may also be adopted. The charge unit may also be a voltage conversion circuit (for example, a DCDC converter), for example.

A configuration is adopted in which the discharge unit according to the above embodiment includes a voltage conversion circuit, but another configuration may be adopted. The discharge unit may also be a switching element, for example.

Note that the embodiments disclosed herein are to be considered as illustrative and non-limiting in all aspects. The scope of the present disclosure is not limited by the embodiments disclosed herein, and all changes that come within the range indicated by the claims or the range of equivalency of the claims are intended to be embraced therein.

1. An onboard control apparatus that is used for an onboard system,
wherein the onboard system includes: a power source unit, a power storage unit different from the power source unit, a power path that is a path for supplying power from the power source unit to a load, a charge unit configured to perform a charge operation of suppling a current to the power storage unit based on power that is supplied from the power source unit, a discharge unit configured to perform a discharge operation of causing a current to flow to the load side based on power that is supplied from the power storage unit, and a switch provided on the power path, and the charge operation by the charge unit and the discharge operation by the discharge unit are controlled,
the power path includes a first power path on the power source unit side relative to the switch and a second power path on the load side relative to the switch,
the charge unit is disposed between the first power path and the power storage unit,
the discharge unit is disposed between the power storage unit and the second power path,
the onboard control apparatus includes a control unit configured to control the charge unit and the discharge unit, and
the control unit switches the switch to an on-state when a voltage of the first power path is higher than a threshold value, switches the switch to an off-state and causes the discharge unit to perform the discharge operation when the voltage of the first power path is lower than or equal to the threshold value, causes the discharge operation by the discharge unit and the charge operation by the charge unit to be performed in parallel when the voltage of the first power path is lower than or equal to the threshold value and a voltage of the power storage unit decreases to a threshold value or lower, and causes the charge unit to stop the charge operation while causing the discharge unit to perform the discharge operation when the voltage of the first power path decreases to a value lower than or equal to a second threshold value that is lower than the threshold value.

2. (canceled)

3. The onboard control apparatus according to claim 1, wherein, during a period during which the discharge operation and the charge operation are performed in parallel, the control unit performs control such that power that is supplied to the power storage unit by the charge unit is higher than or equal to power that is supplied by the discharge unit through discharging.

4. The onboard control apparatus according to of claim 1, wherein the predetermined value is a value that is lower than or equal to the threshold voltage.

5. (canceled)

6. (canceled)

7. The onboard control apparatus according to claim 1,
wherein the discharge unit includes an output conductive path that is a path for supplying a discharge current to the load side, and a voltage conversion circuit for performing a voltage conversion operation of converting an input voltage that is based on the power storage unit and applying an output voltage to the output conductive path,
a disconnection portion configured to stop power supply from the output conductive path to the second power path is further provided,
the control unit causes the voltage conversion circuit to perform the voltage conversion operation even in a state where a voltage of the first power path exceeds the threshold voltage, and
the disconnection portion is configured to cause a current to flow from the output conductive path to the second power path when a voltage of the first power path decreases to the threshold voltage or lower.

8. The onboard control apparatus according to claim 1, wherein the control unit causes the discharge operation to be stopped in a state where the voltage of the first power path exceeds the threshold voltage, and causes the discharge operation to be started when the voltage of the first power path decreases to the threshold voltage or lower.

9. The onboard control apparatus according to claim 1,
wherein the switch is constituted by an FET,
a discharge path is provided between the discharge unit and a connection portion between the switch and the load,
the discharge unit performs the discharge operation such that a current flows through the discharge path, and
the switch stops flow of a current from the load side to the power source unit side via the switch itself in an off-state, and allows such flow in an on-state.

10. The onboard control apparatus according to of claim 3, wherein the predetermined value is a value that is lower than or equal to the threshold voltage.

11. The onboard control apparatus according to claim 3,
wherein the discharge unit includes an output conductive path that is a path for supplying a discharge current to the load side, and a voltage conversion circuit for performing a voltage conversion operation of converting an input voltage that is based on the power storage unit and applying an output voltage to the output conductive path,
a disconnection portion configured to stop power supply from the output conductive path to the second power path is further provided,
the control unit causes the voltage conversion circuit to perform the voltage conversion operation even in a state where a voltage of the first power path exceeds the threshold voltage, and
the disconnection portion is configured to cause a current to flow from the output conductive path to the second power path when a voltage of the first power path decreases to the threshold voltage or lower.

12. The onboard control apparatus according to claim 4,
wherein the discharge unit includes an output conductive path that is a path for supplying a discharge current to the load side, and a voltage conversion circuit for performing a voltage conversion operation of converting an input voltage that is based on the power storage unit and applying an output voltage to the output conductive path,
a disconnection portion configured to stop power supply from the output conductive path to the second power path is further provided,
the control unit causes the voltage conversion circuit to perform the voltage conversion operation even in a state where a voltage of the first power path exceeds the threshold voltage, and
the disconnection portion is configured to cause a current to flow from the output conductive path to the second power path when a voltage of the first power path decreases to the threshold voltage or lower.

13. The onboard control apparatus according to claim 3, wherein the control unit causes the discharge operation to be stopped in a state where the voltage of the first power path exceeds the threshold voltage, and causes the discharge operation to be started when the voltage of the first power path decreases to the threshold voltage or lower.

14. The onboard control apparatus according to claim 4, wherein the control unit causes the discharge operation to be stopped in a state where the voltage of the first power path exceeds the threshold voltage, and causes the discharge operation to be started when the voltage of the first power path decreases to the threshold voltage or lower.

15. The onboard control apparatus according to claim 3,
wherein the switch is constituted by an FET,
a discharge path is provided between the discharge unit and a connection portion between the switch and the load,
the discharge unit performs the discharge operation such that a current flows through the discharge path, and
the switch stops flow of a current from the load side to the power source unit side via the switch itself in an off-state, and allows such flow in an on-state.

16. The onboard control apparatus according to claim 4,
wherein the switch is constituted by an FET,
a discharge path is provided between the discharge unit and a connection portion between the switch and the load,
the discharge unit performs the discharge operation such that a current flows through the discharge path, and
the switch stops flow of a current from the load side to the power source unit side via the switch itself in an off-state, and allows such flow in an on-state.

17. The onboard control apparatus according to claim 7,
wherein the switch is constituted by an FET,
a discharge path is provided between the discharge unit and a connection portion between the switch and the load,
the discharge unit performs the discharge operation such that a current flows through the discharge path, and
the switch stops flow of a current from the load side to the power source unit side via the switch itself in an off-state, and allows such flow in an on-state.

18. The onboard control apparatus according to claim 8,
wherein the switch is constituted by an FET,
a discharge path is provided between the discharge unit and a connection portion between the switch and the load,
the discharge unit performs the discharge operation such that a current flows through the discharge path, and
the switch stops flow of a current from the load side to the power source unit side via the switch itself in an off-state, and allows such flow in an on-state.
